(19) United States
(12) Patent Application Publication
(10) Pub. No.: US 2025/0265857 A1
(43) Pub. Date: Aug. 21, 2025

(54) IMAGE PROCESSING SYSTEM

(71) Applicant: KYOCERA Document Solutions Inc., Osaka (JP)

(72) Inventors: Noa Kaneda, Osaka (JP); Kanako Morimoto, Osaka (JP); Kazunori Tanaka, Osaka (JP); Takeo Shimizu, Osaka (JP)

(21) Appl. No.: 19/052,074

(22) Filed: Feb. 12, 2025

(30) Foreign Application Priority Data
Feb. 20, 2024 (JP) 2024-023407
Feb. 20, 2024 (JP) 2024-023408
Feb. 20, 2024 (JP) 2024-023411

(51) Int. Cl. G06V 30/414; G06T 11/60; G06V 30/413

(52) U.S. Cl. CPC G06V 30/414; G06T 11/60; G06V 30/413

(57) ABSTRACT

An image processing system includes a target image acquiring unit, an instruction object detecting unit, an instruction determining unit, and a replacement processing unit. The target image acquiring unit acquires as a target image a document image of a document. The instruction object detecting unit detects a first instruction object and a second instruction object in the target image among handwritten objects additionally written to the document, the first instruction object specifying a process target object, and the second instruction object specifying data used for a replacement process of the process target object. The instruction determining unit determines the process target object specified by the detected first instruction object and determines the data specified by the detected second instruction object. The replacement processing unit performs a replacement process of the determined process target object with the determined data in the target image.

### CROSS-REFERENCE TO RELATED APPLICATIONS

This application relates to and claims priority rights from Japanese Patent Applications Nos. 2024-023407, 2024-023408, and 2024-023411 filed on Feb. 20, 2024, the entire disclosures of which are hereby incorporated by reference herein.

### BACKGROUND

### 1. Field of the Present Disclosure

The present disclosure relates to an image processing system.

### 2. Description of the Related Art

Regarding a document image obtained by scanning a document that includes a process list of process items “Delete”, “Acquire” and “Restrict”, an image processing apparatus determines a process item specified with a specific color in the process list, and performs the specified process item for a part surrounded by the specific color or a part filled in with the specific color in the document image.

Further, an image processing apparatus (a) separates a handwritten part from a document image of a document, (b) determines whether the handwritten part is a surrounding line that surrounds a target area or a classification symbol that classifies a target area, and (c) classifies an image of the target area with the classification symbol.

It is conceivable to determine a target area of an arbitrary shape specified with a handwritten instruction object such as a surrounding line as mentioned, and replaces the target area with another content. In such a case, if the instruction object is a handwritten object, there is fluctuation on a shape or the like of the instruction object, and therefore, the instruction object may not be properly detected in the target image.

### SUMMARY

An image processing system according to an aspect of the present disclosure includes a target image acquiring unit, an instruction object detecting unit, an instruction determining unit, and a replacement processing unit. The target image acquiring unit is configured to acquire as a target image a document image of a document. The instruction object detecting unit is configured to detect a first instruction object and a second instruction object in the target image among handwritten objects additionally written to the document, the first instruction object specifying a process target object, and the second instruction object specifying data used for a replacement process of the process target object. The instruction determining unit is configured to determine the process target object specified by the detected first instruction object and determine the data specified by the detected second instruction object. The replacement processing unit is configured to perform a replacement process of the determined process target object with the determined data in the target image.

These and other objects, features and advantages of the present disclosure will become more apparent upon reading of the following detailed description along with the accompanied drawings.

### BRIEF DESCRIPTION OF THE DRAWINGS

FIG. 1 shows a block diagram that indicates a configuration of an image processing system in Embodiment 1 of the present disclosure;

FIG. 2 shows a diagram that indicates an example of a target image that includes a first instruction object and a second instruction object;

FIG. 3 shows a diagram that explains objects determined in the target image shown in FIG. 2;

FIG. 4 shows a diagram that indicates an example of a target image after a replacement process;

FIG. 5 shows a flowchart that explains a behavior of the image processing system shown in FIG. 1;

FIG. 6 shows a block diagram that indicates a configuration of an image processing system in Embodiment 2 of the present disclosure;

FIG. 7 shows a diagram that indicates an example of a target image that includes a first instruction object and a second instruction object;

FIG. 8 shows a diagram that explains instruction objects determined in the target image shown in FIG. 7;

FIG. 9 shows a diagram that explains character objects (character areas) determined in the target image shown in FIG. 7;

FIG. 10 shows a diagram that indicates an example of a target image after a replacement process performed for the target image shown in FIG. 7;

FIG. 11 shows a diagram that indicates another example of a target image that includes a first instruction object and a second instruction object;

FIG. 12 shows a flowchart that explains a behavior of the image processing system shown in FIG. 6;

FIG. 13 shows a diagram that indicates another example of a target image that includes a first instruction object and a second instruction object;

FIG. 14 shows a diagram that explains instruction objects determined in the target image shown in FIG. 13; and

FIG. 15 shows a diagram that indicates an example of a target image after a replacement process performed for the target image shown in FIG. 13.

### DETAILED DESCRIPTION

Hereinafter, embodiments according to an aspect of the present disclosure will be explained with reference to drawings.

### Embodiment 1

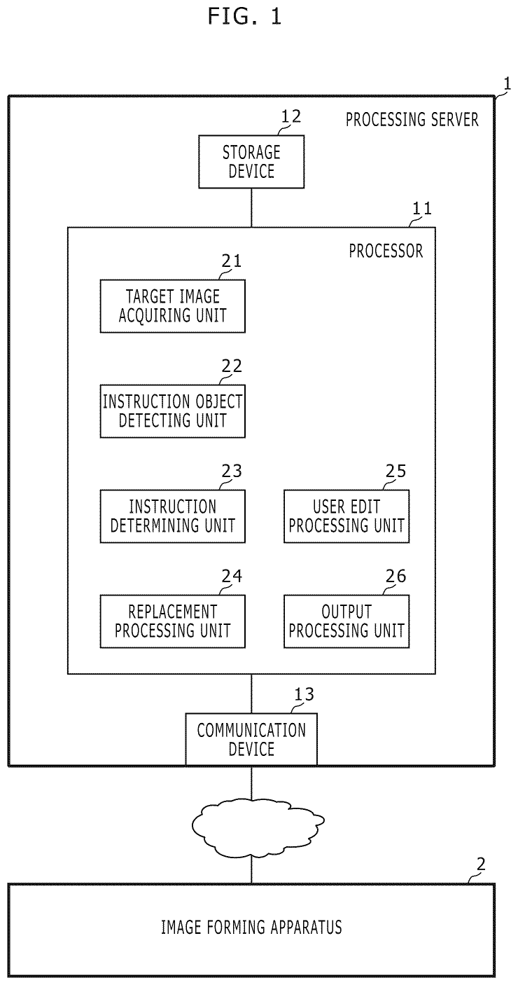

FIG. 1 shows a block diagram that indicates a configuration of an image processing system in an embodiment of the present disclosure. The image processing system shown in FIG. 1 includes a processing server 1 and an image forming apparatus 2 (multi function peripheral or the like), capable of communication through a network with each other.

The processing server 1 includes a processor 11, a storage device 12, and a communication device 13.

The processor 11 includes a computer, and executes a program with the computer and thereby, acts as sorts of processing units. Specifically, the computer includes a CPU (Central Processing Unit), a ROM (Read Only Memory), a RAM (Random Access Memory) and the like, loads a program stored in the ROM or the storage device 12, executes the program with the CPU, and thereby acts as sorts of processing units. Further, the processor 11 may include an ASIC (Application Specific Integrated Circuit) that performs as a specific processing unit.

The storage device 12 is a non-volatile storage device such as flash memory, and stores the image processing program and data required for a process mentioned below. In the storage device 12, system setting data is stored. The system setting data includes parameters of a learner mentioned below.

The communication device 13 such as network interface or a peripheral device interface is a device that performs data communication with an external device such as the image forming apparatus 2.

Meanwhile, the image forming apparatus 2 includes an image scanning device, a communication device, an operation panel and the like, generates as a target image a document image from a document using the image scanning device, and using the communication device, transmits the target image to the processing server 1 and receives the processed target image.

In the processing server 1, the processor 11 acts as a target image acquiring unit 21, an instruction object detecting unit 22, an instruction determining unit 23, a replacement processing unit 24, a user edit processing unit 25, and an output processing unit 26, as the aforementioned processing units.

The target image acquiring unit 21 acquires as a target image (image data of) a document image of a document from the storage device 12, the communication device 13 or the like, and stores the target image into the RAM or the like. For example, this document is a print product outputted by a printing device, and this document image is an image obtained by scanning such document using an image scanning device. For example, this document is a business form or a flyer.

The instruction object detecting unit 22 detects a first instruction object and a second instruction object in the document image among handwritten objects additionally written to the document using object detection with a learner for which machine learning has been performed (such as YOLO (You Only Look Once), SSD (Single Shot MultiBox Object Detector), FasterR-CNN (Regions with Convolutional Neural Networks) or the like), the first instruction object specifies a process target object, and the second instruction object specifies data used for a replacement process of the process target object.

The handwritten objects are individual foreground images other than a background. Further, the machine leaning may be performed using training data that includes a document image in which each instruction object variously handwritten overlaps a movable-type object, and thereby even if the instruction object overlaps a movable-type object in the target image, the instruction object is properly detected. Further, if a size of the document image is different from a size of input data of this learner (i.e. objection detection model), the document image is converted to get the same size as the input data size of the leaner (i.e. objection detection model). For example, if a size of the document image is an A4 size of 300 dpi, i.e. 2480 pixels by 3507 pixels, and the input data size is 640 pixels by 640 pixels, then resolution of the document image is converted, and thereby a size of the document image becomes 640 pixels by 640 pixels. Further, for each of the detected objects, output data of this learner includes a classification (which one of the first instruction object, the second instruction object and an object other than them), a bounding box (i.e. a position and a size of it), and a confidence of the classification (any value from 0 to 1).

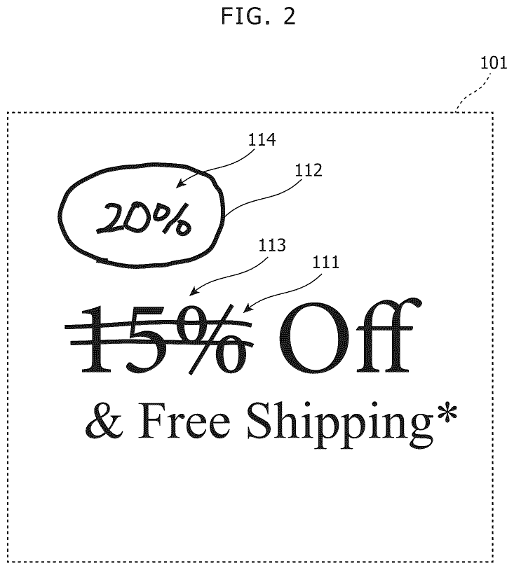

FIG. 2 shows a diagram that indicates an example of a target image that includes a first instruction object and a second instruction object.

Here, the first instruction object and the second instruction object have different shapes from each other. In this embodiment, as shown in FIG. 2, for example, the first instruction object 111 is a strikethrough line (e.g. two lines of straight line shapes, or the like), and the second instruction object 112 is a surrounding line (any closed curved line of a circular shape, or the like).

As shown in FIG. 2, for example, in the target image 101, the first instruction object 111 is described over an object 113 to be changed in the replacement. Further, as shown in FIG. 2, for example, in the target image 101, data 114 used in the replacement (in FIG. 2, “20%”) is described in an area specified by the second instruction object 112 (here, an area inside of the surrounding line).

For the aforementioned learner, the machine learning has been performed using as training data that includes the first and second instruction objects having plural colors, plural line width, and plural shapes. Consequently, a writing implement used to write the first and second instruction objects on a document is not limited, and even if there is fluctuation of a shape of it due to handwriting, the first and second instruction objects are properly detected.

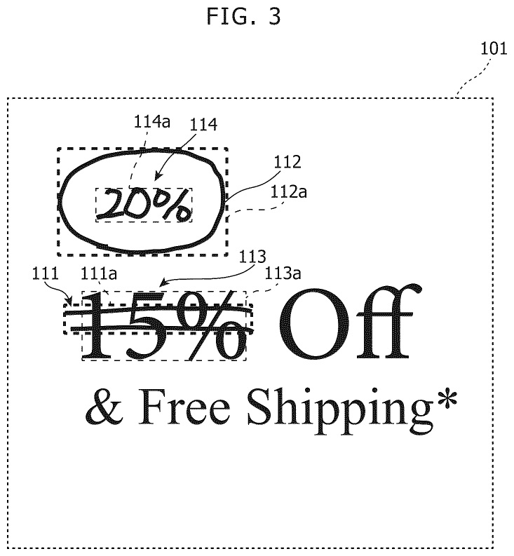

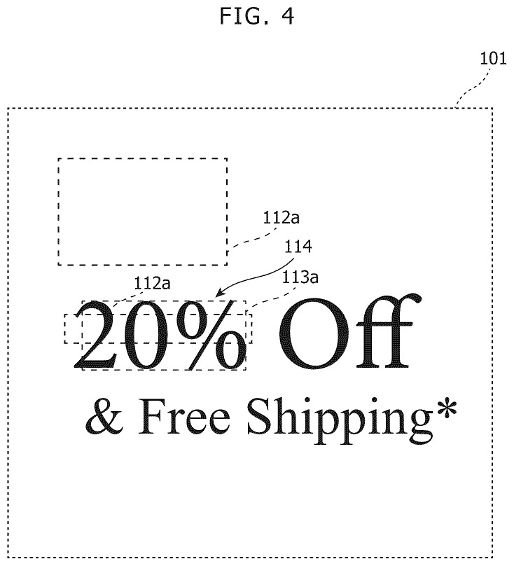

FIG. 3 shows a diagram that explains objects determined in the target image shown in FIG. 2. FIG. 4 shows a diagram that indicates an example of a target image after a replacement process.

As shown in FIG. 3, for example, the instruction determining unit 23 determines a process target object 113 specified by the detected first instruction object 111 and determines data 114 for the replacement process mentioned below, specified by the detected second instruction object 112. As shown in FIG. 4, for example, the replacement processing unit 24 performs a replacement process of the determined process target object 113 with the determined aforementioned data 114 in the target image 101.

Specifically, as shown in FIG. 3, for example, the aforementioned object detection indicates a bounding box 111a of the first instruction object 111 (i.e. a position and a size of the object 111), a bounding box 112a of the second instruction object 112 (i.e. a position and a size of the object 112), a bounding box 113a of the process target object 113 (i.e. a position and a size of the object 113), and a bounding box 114a of the data 114 (i.e. a position and a size of the data 114 as an object); and on the basis of relative positional relationships of them, the instruction determining unit 23 determines the process target object 113 specified by the first instruction object 111, determines the data 114 specified by the second instruction object 112, and associates the first instruction object 111 and the second instruction object 112 with each other in the target image 101.

Further in this embodiment, the instruction object detecting unit 23 performs a character recognition process for an image area specified by the second instruction object and thereby determines text data described in the image area, and the replacement processing unit 24 deletes the process target object and adds an object based on the determined text data at a position of the process target object in the target image (i.e. arranges the object as a foreground image. In this process, the added object (specifically, a text as an object) is generated such that the added object has the same font type, the same color, and the same size as them of the process target object.

Specifically, as show in FIG. 4, the replacement processing unit 24 converts the process target object 113 and the data 114 from raster images to text data (here, “15%” and “20%”) using the character recognition process, deletes the first instruction object 111, the second instruction object 112, the process target t object 113, and the data 114 (specifically, foreground images inside of the bounding boxes 111a, 112a, 113a and 114a), converts the data 114 from text data to a raster image, and adds it at a position of the bounding box 113a.

The user edit processing unit 25 performs edit based on a user operation for the target image after the replacement process. Specifically, the user edit processing unit 25 (a) performs changing the process target object or the data in accordance with the user operation, and (b) performs edit of the target image correspondingly to the changing.

Furthermore, the output processing unit 26 outputs the target image after the aforementioned process. For example, the output processing unit 26 transmits image data of the target image to the image forming apparatus 2, causes the image forming apparatus 2 to print the target image or stores the target image into a predetermined storage device (the image forming apparatus 2, another server or the like).

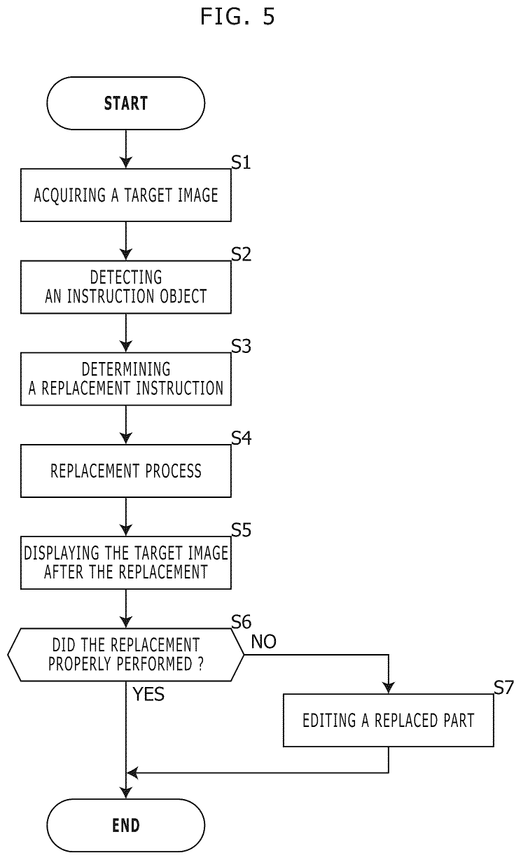

The following part explains a behavior of the aforementioned image processing system. FIG. 5 shows a flowchart that explains a behavior of the image processing system shown in FIG. 1.

The target image acquiring unit 21 acquires a target image (in Step S1). Here, the aforementioned first and second instruction objects and the data 114 are additionally described by handwriting on a document printed by the image forming apparatus 2, and thereafter, a document image is obtained by scanning an image of the document, and the document image (image data) is transmitted as the target image from the image forming apparatus 2 to the processing server 1.

In the processing server 1, upon obtaining the target image, the object detecting unit 22 detects the first instruction object 111 and the second instruction object 112 with the process target object 113 and the data 114 in the target image 101 using object detection (in Step S2).

On the basis of a result of the objection detection, the instruction determining unit 23 determines the process target object 113 specified by the detected first instruction object 111, and determines the data 114 specified by the detected second instruction object 112 (in Step S3). Here, determined are a relationship between the first instruction object 111 and the process target image 113, a relationship between the second instruction object 112 and the data 114, and a relationship between the first instruction object 111 and the second instruction object 112.

Subsequently, the replacement processing unit 24 performs the replacement process of the determined process target object 113 with the determined aforementioned data 114 in the target image 101 on the basis of the relationships determined by the instruction determining unit 23 (in Step S4).

After the replacement process is finished, the user edit processing unit 25 transmits to the image forming apparatus 2 the target image for which the replacement process has been performed, and causes the image forming apparatus 2 to display it. The image forming apparatus 2 displays on a display device or the like the target image for which the replacement process has been performed (in Step S5).

The user visually confirms the displayed target image, determines whether the replacement process has been properly performed or not, and performs a user operation that indicates the determination result, to the image forming apparatus 2 (an input device of an operation panel of it). Further, if the user determined that the replacement process has not been properly performed, then the user performs a user operation for edit to the image forming apparatus 2 (an input device of an operation panel of it). The image forming apparatus 2 informs the user edit processing unit 25 of the processing server 1 of these user operations.

The user edit processing unit 25 determines whether the replacement process has been properly performed or not on the basis of the information (in Step S6). If it is determined that the image process has been properly performed, then the output processing unit 26 outputs the target image for which the replacement process has been performed.

Contrarily, if it is determined that the image process has not been properly performed, then the user edit processing unit 25 (a) performs changing the process target object 113 or the data 114 in accordance with the informed user operation, and (b) performs edit of the target image correspondingly to the changing (in Step S7). Afterward, the output processing unit 26 outputs the edited target image.

For example, an EDIT key (soft key) is displayed so as to be adjacent to the data 114 added by the replacement process in the target image; and if the EDIT key is pressed, a dialog is displayed, a user operation to input edit details is performed to the dialog, and in accordance with the user operation, changing the process target object 113 or the data is performed.

As shown in FIG. 4, for example, when “15%” was replaced with “20%”, if a user wants to change it to another value (“35%” or the like) or if “26%” is misdetected as “20%” in the character recognition process, then a proper value (“35%” or “26%” as mentioned) for the user is inputted, and the user edit processing unit 25 changes a part corresponding to the data 114 in the target image to an image of the inputted value.

Further, as shown in FIGS. 3 and 4, if the process target object 113 should be recognized as “15%” but is recognized as “15” in error and the replacement process changes “15%” to “20%” for example, then in accordance with a user operation, a range of the process target object 113 (i.e. a range of an object specified by the first instruction object 111) is changed (here, enlarged) to “15%” and then the user edit processing unit 25 causes the replacement processing unit 24 to perform the replacement process again on the basis of the changed process target image 113 and thereby causes to properly replace “15%” with “20%”.

As mentioned, in Embodiment 1, the instruction object detecting unit 22 detects a first instruction object and a second instruction object in the target image among handwritten objects additionally written to the document, and here the first instruction object specifies a process target object, and the second instruction object specifies data used for a replacement process of the process target object. The instruction determining unit 23 determines the process target object 113 specified by the detected first instruction object 111, and determines the data 114 specified by the detected second instruction object 112. The replacement processing unit 24 performs a replacement process of the determined process target object 113 with the determined data 114 in the target image 101.

Consequently, using object detection removes limitation on a writing implement used to write the first and second instruction objects 111 and 112 on a document, and the instruction objects 111 and 112 to specify targets used for the replacement process are properly detected in the target image.

### Embodiment 2

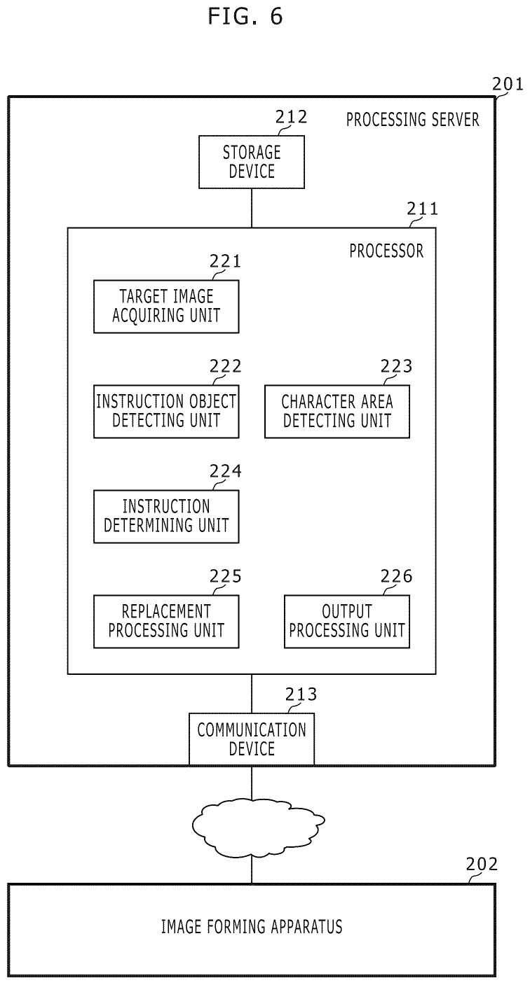

FIG. 6 shows a block diagram that indicates a configuration of an image processing system in Embodiment 2 of the present disclosure. The image processing system shown in FIG. 6 includes a processing server 201 and an image forming apparatus 202 (multi function peripheral or the like) similar to the image forming apparatus 2, capable of communication through a network with each other.

The processing server 201 includes a processor 211 identical or similar to the processor 11, a storage device 212 identical or similar to the storage device 12, and a communication device 213 identical or similar to the communication device 13.

In the processing server 201, the processor 211 acts as a target image acquiring unit 221, an instruction object detecting unit 222, a character area detecting unit 223, an instruction determining unit 224, a replacement processing unit 225, and an output processing unit 226.

The target image acquiring unit 221 is a processing unit identical or similar to the target image acquiring unit 21.

The instruction object detecting unit 222 detects a first instruction object and a second instruction object in the target image among handwritten objects additionally written to the document, as well as the instruction object detecting unit 22. Here, the first instruction object specifies a process target object, and the second instruction object specifies a replacement object used for a replacement process of the process target object.

A handwritten object, and input data and output data of the learner in Embodiment 2 are identical or similar to the handwritten object, and the input data and the output data of the learner in Embodiment 1.

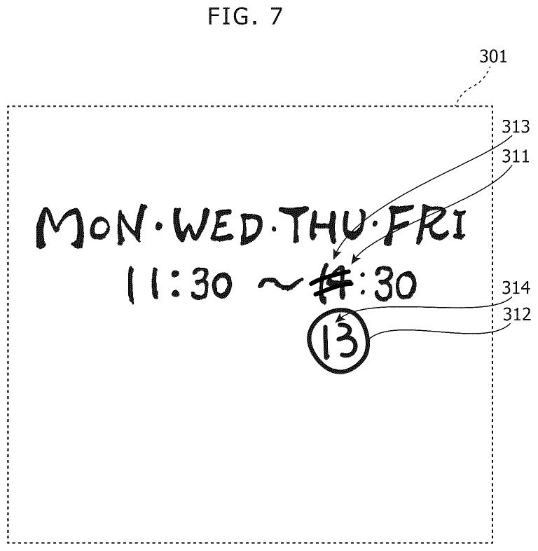

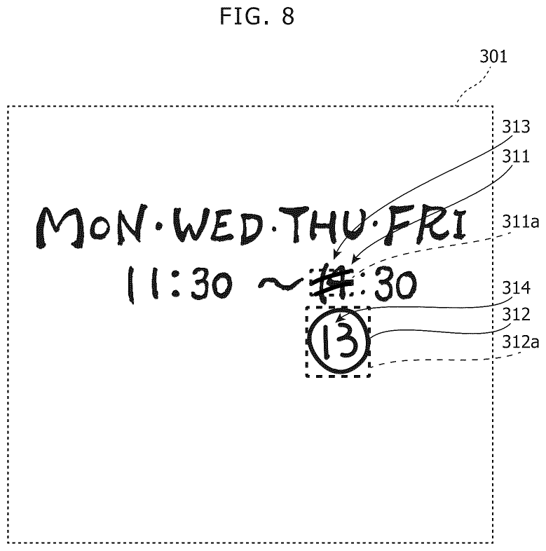

FIG. 7 shows a diagram that indicates an example of a target image that includes a first instruction object and a second instruction object. FIG. 8 shows a diagram that explains instruction objects determined in the target image shown in FIG. 7.

Here, the first instruction object and the second instruction object have different shapes from each other. In this embodiment, as shown in FIG. 7, for example, the first instruction object 311 is a strikethrough line (e.g. two lines of straight line shapes, or the like), and the second instruction object 312 is a surrounding line (any closed curved line of a circular shape, or the like).

As shown in FIG. 7, for example, the first instruction object 311 is described over an object 313 (in FIG. 7, “14”) to be changed in the replacement process in a target image 301. Further, as shown in FIG. 7, for example, in the target image 301, a replacement object 314 (in FIG. 7, “13”) is described in an area specified by the second instruction object 312 (here, an area inside of a surrounding line).

Furthermore, as shown in FIG. 8, for example, using the aforementioned object detection, the instruction object detecting unit 222 determines a bounding box 311a of the first instruction object 311 (i.e. a position and a size of the object 311) and a bounding box 312a of the second instruction object 312 (i.e. a position and a size of the object 312).

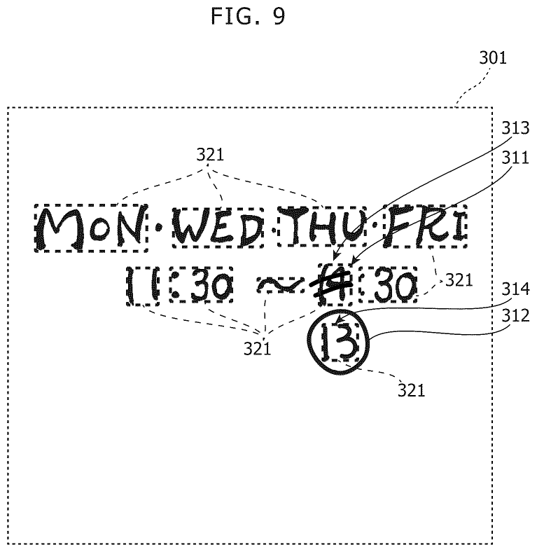

FIG. 9 shows a diagram that explains character objects (character areas) determined in the target image shown in FIG. 7.

Further, the character area detecting unit 223 detects character objects 321 (i.e. character areas) of a movable-type character and a handwritten character in the target image 301, as shown in FIG. 9, for example, using an existing character recognition process. Specifically, the character area detecting unit 223 determines a bounding box of each of the character objects 321.

Further, the instruction determining unit 224 determines a process target object 313 specified by the detected first instruction object 311 and determines a replacement object 314 specified by the detected second instruction object 312.

Specifically, a character object 321 nearest to a position of the first instruction object 311 determined as mentioned (i.e. a character object 321 of which a bounding box overlaps a bounding box of the first instruction object 311) is identified as a process target object 313, and a character object 321 nearest to a position of the second instruction object 312 determined as mentioned is identified as a replacement object 314. Further, on the basis of a relative positional relationship between them and/or the like, the instruction determining unit 224 associates with each other the first and second instruction object 311 and 312 adjacent to each other in the target image 301.

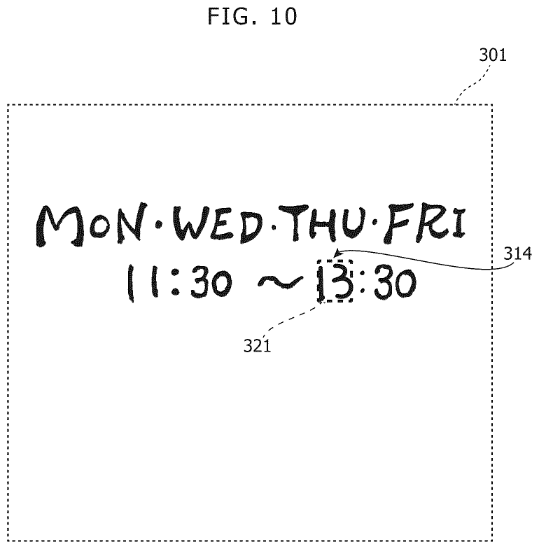

FIG. 10 shows a diagram that indicates an example of a target image after a replacement process performed for the target image shown in FIG. 7.

As shown in FIG. 10, for example, the replacement processing unit 225 performs a replacement process of the determined process target object 313 with the determined aforementioned replacement object 314 in the target image 301.

In Embodiment 2, the replacement processing unit 225 deletes the process target object 313 and adds as an image object the replacement object 314 (i.e. raster image) specified by the detected second instruction object 312 at a position of the process target object in the target image 301.

In this process, the replacement processing unit 225 generates a replacement object 314 to be added such that the added object has the same font type, the same color, and the same size as them of the process target object 313. In this process, a size of the replacement object 314 to be added such that a size of a bounding box of the replacement object 314 to be added (here, a bounding box of the corresponding character object 321) agrees with a size of a bounding box of the process target object 313 (here, a bounding box of the corresponding character object 321), namely such that widths and/or heights of the both agree with each other of the both.

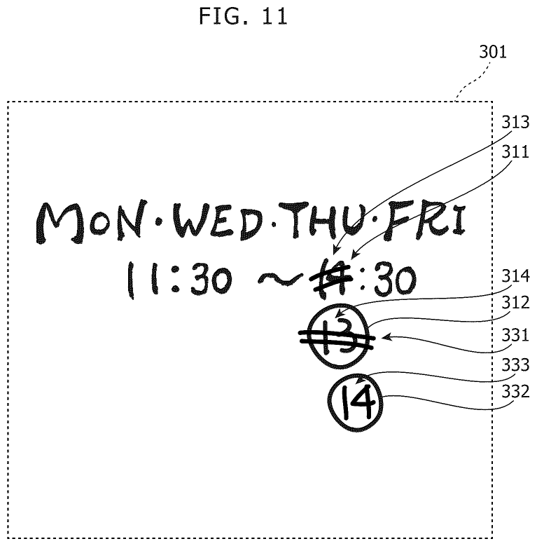

FIG. 11 shows a diagram that indicates another example of a target image that includes a first instruction object and a second instruction object. As shown in FIG. 11, for example, if another first instruction object 331 overlaps the second instruction object 312 and/or the replacement object 314, and another second instruction object 332 and another replacement object 333 are included in the target image 301, then the aforementioned replacement process is performed without the second instruction object 312 and/or the replacement object 314 overlapped by the other first instruction object 331, on the basis of the other second instruction object 332 and the other replacement object 333.

Further, the output processing unit 226 is a processing unit identical or similar to the output processing unit 26.

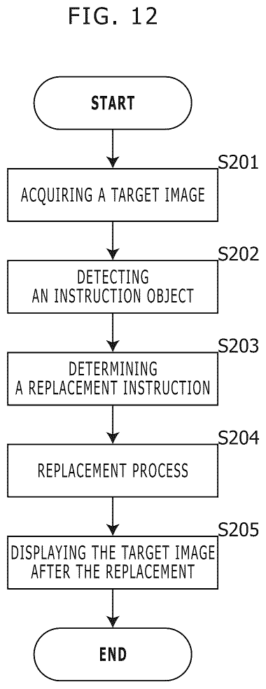

The following part explains a behavior of the image processing system in Embodiment 2. FIG. 12 shows a flowchart that explains a behavior of the image processing system shown in FIG. 6.

In the processing server 201, the target image acquiring unit 221 acquires a target image as well as in Embodiment 1 (in Step S201).

In the processing server 201, upon obtaining the target image, the object detecting unit 222 detects the first instruction object 311 and the second instruction object 312 in the target image 301 using object detection (in Step S202). Further, the character area detecting unit 223 detects a character object 321 in the target image 301.

On the basis of a result of the objection detection and detection result of the character object, the instruction determining unit 224 determines the process target object 313 specified by the detected first instruction object 311, and determines the replacement object 314 specified by the detected second instruction object 312 (in Step S203). Here, determined are a relationship between the first instruction object 311 and the process target image 313, a relationship between the second instruction object 312 and the replacement object 314, and a relationship between the first instruction object 311 and the second instruction object 312.

Subsequently, the replacement processing unit 225 performs the replacement process of the determined process target object 313 with the determined aforementioned replacement object 314 in the target image 301 on the basis of the relationships determined by the instruction determining unit 224 (in Step S204).

After the replacement process is finished, the output processing unit 226 performs displaying or the like of the target image for which the replacement process has been performed (in Step S205).

Other parts of the configuration and behaviors of the image processing system in Embodiment 2 are identical or similar to those in Embodiment 1, and therefore not explained here.

As mentioned, in Embodiment 2, the instruction object detecting unit 222 detects a first instruction object 311 and a second instruction object 312 in a target image 301 among handwritten objects additionally written to a document of the target image, and here the first instruction object specifies a process target object, and the second instruction object specifies a replacement object used for a replacement process of the process target object. The instruction determining unit 224 determines a process target object 313 specified by the detected first instruction object 311 and determines a replacement object 314 specified by the detected second instruction object 312. The replacement processing unit 225 performs a replacement process of the determined process target object 313 with the determined replacement object 314 in the target image 301.

In particular, in Embodiment 2, the process target object 313 is replaced with an image object (raster image) of the replacement object 314.

Consequently, using object detection removes limitation on a writing implement used to write the first and second instruction objects 311 and 312 on a document, and the instruction objects 311 and 312 to specify targets used for the replacement process are properly detected in the target image 301.

### Embodiment 3

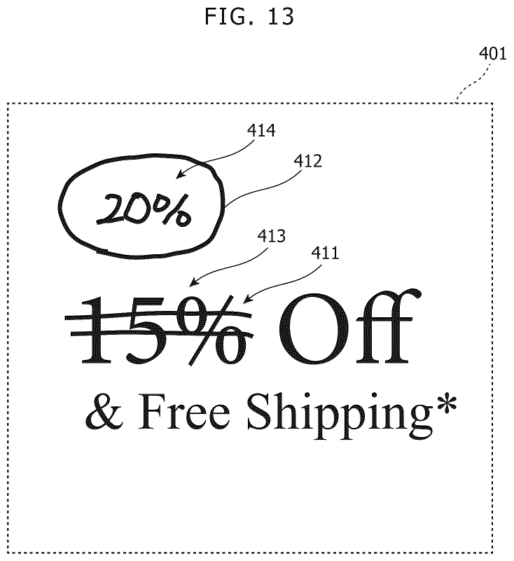

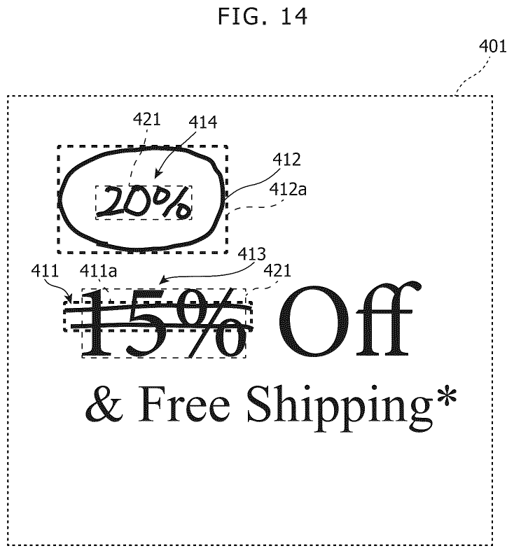

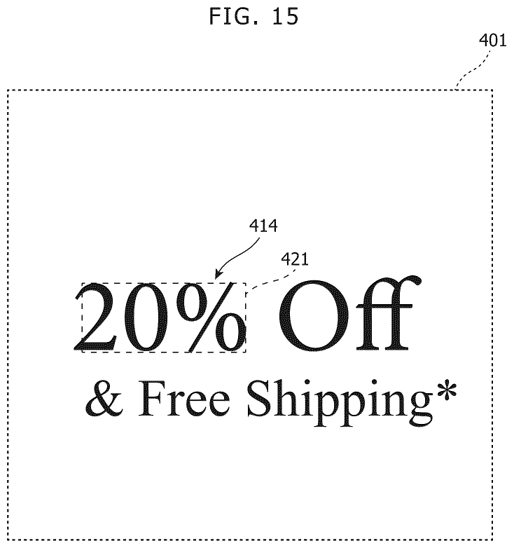

FIG. 13 shows a diagram that indicates another example of a target image that includes a first instruction object and a second instruction object. FIG. 14 shows a diagram that explains instruction objects determined in the target image shown in FIG. 13. FIG. 15 shows a diagram that indicates an example of a target image after a replacement process performed for the target image shown in FIG. 13.

For example, in a target image 401 shown in FIG. 13, the instruction object detecting unit 222 detects a first instruction object 411 (a bounding box 211a) and a second instruction object 412 (a bounding box 212a), and the character area detecting unit 223 detects a character object 421. The instruction determining unit 224 determines a process target object 413 specified by the detected first instruction object 411 and determines a replacement object 414 specified by the detected second instruction object 412.

In Embodiment 3, the replacement processing unit 225 performs a character recognition process for the replacement object 414 and thereby converts the replacement object 44 (here, a raster image of “20%”) to text data. Further, the replacement processing unit 225 deletes the process target object 413 (and the first instruction object 411, the second instruction object 412, and the replacement object 414), and adds an image object based on the text data (i.e. a raster image obtained by rasterizing the text data) at a position of the process target object 413 (i.e. arranges this object as a foreground image). In this process, the replacement processing unit 225 generates the image object to be added such that this image object (specifically, a character in the image object) has the same font type, the same color, and the same size as them of the process target object 413.

In Embodiment 3, if a font type of the process target object 413 can not be determined or if the process target object 413 is a handwritten character, then the replacement processing unit 225 may determine a font type nearest to the process target object 413 on the basis of a character shape of it and generate the image object corresponding to the replacement object 414 with the determined font type. Alternatively, if a font type of the process target object 413 can not be determined or if the process target object 413 is a handwritten character, then the replacement processing unit 225 may generate the image object corresponding to the replacement object 414 with a font type specified by a user (i.e. by a user setting or a user operation).

Other parts of the configuration and behaviors of the image processing system in Embodiment 3 are identical or similar to those in Embodiment 1 or 2, and therefore not explained here.

### Embodiment 4

In Embodiment 4, the replacement object 314 used for the replacement process is selectable as any one of text data and image data by a user.

In Embodiment 4, the replacement processing unit 225 determines an operation mode specified by a user (a user setting stored in advance or a user operation).

If the determined operation mode is a first mode, then as well as in Embodiment 2, the replacement processing unit 225 deletes the process target object and adds as an image object the replacement object (i.e. raster image) specified by the detected second instruction object at a position of the process target object in the target image.

Contrarily, if the determined operation mode is a second mode, then as well as in Embodiment 3, the replacement processing unit 225 (a) performs a character recognition process for the replacement object specified by the second instruction object and thereby converts the replacement object to text data, and (b) deletes the process target object and adds an image object based on the text data at a position of the process target object in the target image.

Other parts of the configuration and behaviors of the image processing system in Embodiment 4 are identical or similar to those in any of Embodiments 1 to 3, and therefore not explained here.

It should be understood that various changes and modifications to the embodiments described herein will be apparent to those skilled in the art. Such changes and modifications may be made without departing from the spirit and scope of the present subject matter and without diminishing its intended advantages. It is therefore intended that such changes and modifications be covered by the appended claims.

For example, in Embodiment 1, the user edit processing unit 25 may be installed in the image forming apparatus 2, rather than in the processing server 1.

Further, in Embodiment 1, the replacement process is performed after the data 114 is converted to text data. Alternatively, the replacement process may be performed using image data (raster image data) of the data 114. In the aforementioned example, a character (number or the like) is described as the data 114 by handwriting, but the data 114 may be a handwritten figure or the like.

Furthermore, in the aforementioned embodiments 1 to 4, the processing server 1 or 201 may be installed in the image forming apparatus 2 or 202.

Furthermore, in Embodiments 1 to 4, the first instruction object is a strikethrough line but may be an underline, a band-shaped line by a light transparency marker such as fluorescent marker, or the like. A writing implement used to add the aforementioned instruction objects to a document may be a light transparency marker, a ballpoint pen, a pencil or the like, and may be a writing implement of which a writing color is an achromatic color or may be a writing implement of which a writing color is a chromatic color.

Furthermore, in Embodiments 2 to 4, the character area detecting unit 223 may convert character objects in a target image to a series of text data using a character recognition process, perform a morphological analysis for the series of the text data, and set as a target of the aforementioned replacement process a part or all of morphemes in text data of the process target object corresponding to morphemes of text data of the replacement object.

Furthermore, in Embodiments 2 to 4, when the first and second instruction objects, the process target object, and the replacement object are deleted, for example, in accordance with an existing image inpainting technique, these objects are replaced with a background image on the basis of a surrounding background of these objects such that an area of these objects are matched to the surrounding background after the deletion.

Furthermore, in Embodiments 2 to 4, the replacement object may be extracted as a character object detected by the character area detecting unit 223, and otherwise may be extracted as a remaining object in a bounding box of the second instruction object (surrounding line or the like) after deleting the second instruction object from a foreground image in the bounding box.

Furthermore, in Embodiments 2 to 4, the character area detecting unit 223 detects a character object. Alternatively, the instruction object detecting 222 may detect the character object together with the instruction objects in a target image.

What is claimed is:

1. An image processing system, comprising:
a target image acquiring unit configured to acquire as a target image a document image of a document;
an instruction object detecting unit configured to detect a first instruction object and a second instruction object in the target image among handwritten objects additionally written to the document, the first instruction object specifying a process target object, and the second instruction object specifying data used for a replacement process of the process target object;
an instruction determining unit configured to determine the process target object specified by the detected first instruction object and determine the data specified by the detected second instruction object; and
a replacement processing unit configured to perform a replacement process of the determined process target object with the determined data in the target image.

2. The image processing system according to claim 1, wherein the first instruction object and the second instruction object have different shapes from each other.

3. The image processing system according to claim 2, wherein the first instruction object is a strikethrough line; and
the second instruction object is a surrounding line.

4. The image processing system according to claim 1, wherein for the learner the machine learning has been performed using as training data plural document images that include the first and second instruction objects having plural colors, plural line width, and plural shapes.

5. The image processing system according to claim 1, wherein for each of the detected objects, the learner outputs at least classifications including the first and second instruction objects, and a bounding box of each of the detected objects;
on the basis of the bounding boxes, the instruction determining unit determines the process target object specified by the detected first instruction object, and determines the data specified by the detected second instruction object.

6. The image processing system according to claim 1, wherein the instruction determining unit performs a character recognition process for an image area specified by the second instruction object and thereby determines text data described in the image area; and
the replacement processing unit deletes the process target object and adds an object based on the determined text data at a position of the process target object in the target image.

7. The image processing system according to claim 1, further comprising a user edit processing unit configured to perform edit based on a user operation for the target image after the replacement process;
wherein the user edit processing unit (a) performs changing the process target object or the data in accordance with the user operation, and (b) performs edit of the target image correspondingly to the changing.

8. The image processing system according to claim 1, wherein the instruction object detecting unit detects a first instruction object and a second instruction object in the target image among handwritten objects additionally written to the document, the first instruction object specifying a process target object, and the second instruction object specifying a replacement object used for a replacement process of the process target object;
the instruction determining unit determines the process target object specified by the detected first instruction object and determine the replacement object specified by the detected second instruction object; and
the replacement processing unit performs a replacement process of the determined process target object with the determined replacement object in the target image.

9. The image processing system according to claim 8, wherein the replacement processing unit (a) performs a character recognition process for the replacement object specified by the second instruction object and thereby converts the replacement object to text data, and (b) deletes the process target object and adds an image object based on the text data at a position of the process target object in the target image.

10. The image processing system according to claim 8, wherein the replacement processing unit deletes the process target object and adds as an image object the replacement object specified by the detected second instruction object at a position of the process target object in the target image.

11. The image processing system according to claim 8, wherein the replacement processing unit determines an operation mode specified by a user;
if the operation mode is a first mode, the replacement processing unit deletes the process target object and adds as an image object the replacement object specified by the detected second instruction object at a position of the process target object in the target image; and
if the operation mode is a second mode, the replacement processing unit (a) performs a character recognition process for the replacement object specified by the second instruction object and thereby converts the replacement object to text data, and (b) deletes the process target object and adds an image object based on the text data at a position of the process target object in the target image.

12. The image processing system according to claim 9, wherein the replacement processing unit generates the image object so as to make a size of the image object agree with a size of the process target object.
